(19) United States
(12) Patent Application Publication
(10) Pub. No.: US 2026/0278146 A1
(43) Pub. Date: Sep. 17, 2026

(54) ROW-LEVEL SECURITY ON CALCULATION VIEWS IN DATABASE SYSTEMS

(71) Applicant: SAP SE, Walldorf (DE)

(72) Inventors: Yinghua Ouyang, Xi'an (CN); Xun Zhang, Xi'an (CN); Yanchen Cao, Xi'an (CN); Boyang Zhang, Xi'an (CN); Zhen Tian, Xi'an (CN); Jane Jung Lee, Seoul (KR)

(21) Appl. No.: 19/080,999

(22) Filed: Mar. 17, 2025

(51) Int. Cl. G06F 21/62; G06F 16/2453

(52) U.S. Cl. CPC G06F 21/6227; G06F 16/24542

(57) ABSTRACT

Methods, systems, and computer-readable storage media for providing an initial query tree responsive to a query for querying a database system, the initial query tree including a set of calculation view nodes, determining that all calculation views represented on the set of calculation view nodes can be unfolded, and in response, for a calculation view node in the set of calculation view nodes, identifying a condition provider procedure that is to be executed, executing the condition provider procedure to provide a filter string, and inserting the filter string into the initial query tree, providing a final query tree including the initial query tree and inserted filter strings, generating a query execution plan, executing, by an execution engine, the query execution plan to query a database and generate results responsive to the query, and returning the results.

### BACKGROUND

Database systems store data that can be queried. For example, a query can be submitted to a database system, which processes the query and provides a result. Queries are submitted in a query language. An example query language includes, without limitation, the structured query language (SQL), which can be described as a standard database language that is used to create, maintain and retrieve data stored in a relational database (e.g., a database, in which data is stored in relational tables). Access to data can be restricted. For example, users and/or applications can have access to some data and may be denied access to other data. In querying a database system, an authorization check is performed to ensure that a source of the query (e.g., a user and/or an application querying a database system) is authorized to access data that may be returned in response to the query.

### SUMMARY

Implementations of the present disclosure are directed to providing row-level security in databases systems. More particularly, implementations of the present disclosure are directed to processing queries to enforce row-level security on calculation views in database systems.

In some implementations, actions include providing a first initial query tree responsive to a first query for querying a database system, the first initial query tree including a first set of calculation view nodes, determining that all calculation views represented on the first set of calculation view nodes can be unfolded, and in response, for a first calculation view node in the first set of calculation view nodes, identifying a first condition provider procedure that is to be executed, executing the first condition provider procedure to provide a first filter string, and inserting the first filter string into the initial query tree, providing a first final query tree including the first initial query tree and inserted filter strings, generating a first query execution plan, executing, by an execution engine, the first query execution plan to query a database and generate first results responsive to the first query, and returning the first results. Other implementations of this aspect include corresponding systems, apparatus, and computer programs, configured to perform the actions of the methods, encoded on computer storage devices.

These and other implementations can each optionally include one or more of the following features: the first filter string is determined by the first condition provider procedure from a permission table; the permission table defines a set of filter strings that are to be applied to respective calculation views of calculation view nodes; providing a first final query tree comprising the first initial query tree and inserted filter strings comprises, for the first calculation view, translating a non-relational calculation model to relational form and adding the first filter string as a post-filter into the initial query tree; the post-filter comprises a SELECT operation; actions further include, for a second calculation view node in the set of calculation view nodes, determining that no condition provider procedure is to be executed, such that the second calculation view node is absent filtering; and actions further include providing a second initial query tree responsive to a second query for querying the database system, the second initial query tree including a second set of calculation view nodes, determining that at least one calculation view represented on the second set of calculation view nodes cannot be unfolded, and in response, generating a second query execution plan including the at least one calculation view, and generating a third query execution plan specific to the at least one execution view and including a filter, executing, by a query execution engine of the execution engine, the second query execution plan to query the database and generate second results responsive to the second query, executing, by a calculation engine of the execution engine, the third query execution plan to query the database and generate third results responsive to the second query, and returning the second results and the third results.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture for instituting row-level security in database systems in accordance with implementations of the present disclosure.

FIGS. 3A-3D depict examples to illustrate implementations of the present disclosure.

FIGS. 4A-4C depict example processes that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to providing row-level security in databases systems. More particularly, implementations of the present disclosure are directed to processing queries to enforce row-level security on calculation views in database systems.

Implementations can include actions of providing an initial query tree responsive to a query for querying a database system, the initial query tree including a set of calculation view nodes, determining that all calculation views represented on the set of calculation view nodes can be unfolded, and in response, for a calculation view node in the set of calculation view nodes, identifying a condition provider procedure that is to be executed, executing the condition provider procedure to provide a filter string, and inserting the filter string into the initial query tree, providing a final query tree including the initial query tree and inserted filter strings, generating a query execution plan, executing, by an execution engine, the query execution plan to query a database and generate results responsive to the query, and returning the results.

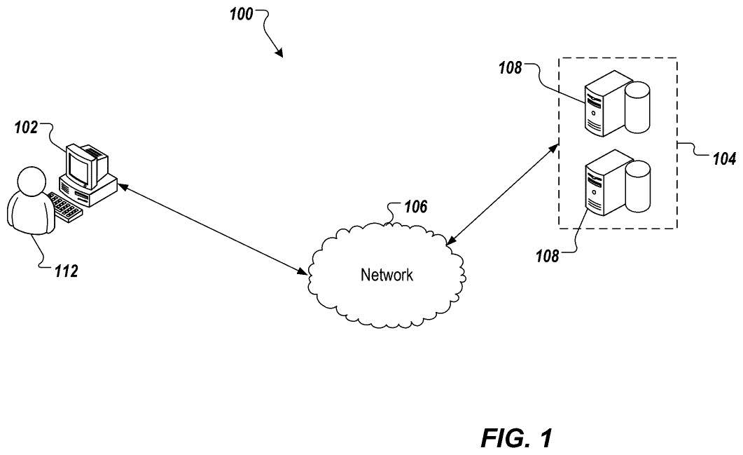

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a database system that stores data in tables. In some examples, the database system receives a query (e.g., from a user, from an application) that includes query authorization data (e.g., user role data, user group data). For example, the user 112 can submit a query to the database system through the client device 102. In some examples, the query includes query authorization data, such as user role data and/or user group data. For example, the user 112 can be logged into the database system and be associated with user profile data, which includes the query authorization data. As described in further detail herein, users, such as the user 112, are associated with privilege levels that enable access to certain data and prohibit access to certain data at a row level.

To provide context for implementations of the present disclosure, and as introduced above, database systems store data that can be queried. Increasingly, database systems store massive amounts of data as data warehousing, big data, and Internet-Of-Things (IoT), for example, progress. In some database systems, data is stored in tables that include rows, each row representing a record, and columns, each column representing a field of a record. In some examples, a query can be submitted to a database system, which processes the query and provides a result. Queries are submitted in a query language. An example query language includes, without limitation, the structured query language (SQL), which can be described as a standard database language that is used to create, maintain and retrieve data stored in a relational database (e.g., a database, in which data is stored in relational tables).

In querying database systems, analytic models are used to define more advanced slices on data, which can be returned in so-called calculation views. For example, analytic models can have layers of calculation logic, can include measures sourced from multiple tables, can include advanced query logic, and the like, to provide results in calculation views. The data foundation of an analytic model can include any combination of tables, column views, attribute views, and analytic views. For example, joins, unions, projections, and aggregation levels can be created on the tables.

In some instances, a calculation view can be unfolded. More particularly, a calculation view is view object that is based on functions that can be executed in a calculation engine language. These functions are commonly referred to as calculation engine (CE) functions. Unlike standard views (e.g., SQL views) that can be read using the query language, calculation views cannot. Due to this language difference, the optimizer, which only interprets the query language (e.g., SQL) cannot interpret a CE function unless specifically coded to do so. In this context, unfolding of a calculation view can be described as a mechanism used to pass interpretable query statements to the optimizer by literally unfolding the compactly wrapped CE functions. In short, while a query language (e.g., SQL) is relational, calculation views are non-relational and, as such, calculation views can be unfolded to be translated into relational form wherever possible.

As further context, access to data can be restricted. That is, for example, security can be applied to data, such that only authorized users are able to access the data. This can be referred to as access control. For example, users and/or applications can have access to some data and may be denied access to other data. In querying a database system, an authorization check is performed to ensure that a source of the query (e.g., a user and/or an application querying a database system) is authorized to access data that may be returned in response to the query.

One concept in providing multi-level and fine granular access control is row-level security, which applies access control to records by row. More particularly, row-level security enables different users to access different portions of data in the same database object. As a non-limiting example, while sales data for all regions are contained within an analytic view, regional sales managers (e.g., a defined role) are only allowed to see the data for their respective region.

However, traditional row-level security suffers from disadvantages. For example, calculation views have different execution patterns. For example, one calculation view can be unfolded for optimization, while another calculation view can be processed as a single column search (e.g., by a calculation engine). In view of these disparate execution patterns, traditional database systems do not support row-level security on calculation views. As a workaround, users are required to write overly complex inner joins and/or functions to implement row-level security on calculation views.

As a result, traditional row-level security injects a level of complexity (e.g., defining dedicated condition providers for each view), which expends technical resources, but also reduces query performance in applying row-level security during query processing. That is, queries can take longer and expend more technical resources (e.g., processing, memory) than desired. Such performance degradation is compounded in querying against relatively large tables using row-level security.

In view of the above context, implementations of the present disclosure provide time- and resource-efficient row-level security for database systems. As described in further detail herein, implementations of the present disclosure support row-level security on calculation views regardless of underlying execution patterns. In some implementations, it is determined whether a can be unfolded by an optimizer. If the calculation view can be unfolded, unfolding is executed to translate non-relational calculation models into relational form and, during the translation, a dynamically generated filter predicate string for row-level security is added to query entries as a post filter. If the calculation view cannot be unfolded, the calculation view is handled by a CE, which executes CE instantiation, CE optimizer, and CE execution processes. During CE instantiation, a filter predicate string for row-level security is added as a post filter. Consequently, row-level security is provided, such different users will see different portions of data for the same calculation view (analytic model) regardless of execution patterns of the calculation view (e.g., unfolding, not unfolding).

To provide context for implementations of the present disclosure, a high-level discussion of query processing is provided. More particularly, and as introduced above, database systems store data in tables and enable queries to be executed to provide query results that can include, for example, one or more views on the data stored in the tables. Among other operations, queries can join, project, and aggregate data stored in tables using relational operators to provide query results. In some instances, the data models and queries can implicate hundreds, if not thousands of database tables and provide relatively large query results over upwards of millions and even billions of records. In some instances, queries resulting in such relatively large query results can be executed at relatively high frequencies, which produces large workloads for the database system.

In further detail, query execution can include parsing using a parser, optimizing using an optimizer, and executing using an execution engine, each of which can be provided as one or more computer-executable programs. In some examples, the parser parses the query to define a data structure that enables further processing. In some examples, the data structure includes a query parse (QP) tree (also referred to as a query tree, a parse tree, or an abstract syntax tree (AST)), which can be described as a tree representation of the abstract syntactic structure of the query written in a query language (e.g., SQL). The query tree includes nodes, each node representing a clause (e.g., SELECT clause, FROM clause) of the query.

In some examples, the QP tree is normalized, which includes determining column and table names, transforming the QP tree into a conjugate normal form (CNF), and resolving datatypes. In some examples, a preprocessor transforms the QP tree for some types of query statements, such as query statements with sub-queries and views, to a more efficient QP tree. In some examples, an optimizer analyzes possible combinations of operations (e.g., join ordering, access and join methods, parallelism) to execute query statements and select a combination of operations that is determined to be most efficient in terms of cost estimates of the alternatives (e.g., cost in terms of time to execute, cost in terms of technical resources consumed to execute). In some examples, a code generator converts the QP tree generated by the parser into query compilation (QC) tree, which is a format that is suitable for optimization. In some examples, the optimizer can execute optimization, during which the QC tree is converted to a query optimization (QO) tree, rewrite the QO tree, and determine specific algorithm for each QO node.

To provide further context, a QP tree can be referred to as an abstract syntax tree (AST), while the QC tree is a relational algebra tree. Unlike an AST, a relational algebra tree can depict the execution sequence of a query statement, progressing from leaf nodes upward to a root node. The QP tree is instrumental in constructing the QO tree. By way of non-limiting example, when a SQL query is execute, the database management system first parses the query, checking for syntax errors. The result of this parsing is a QP tree, which is an intermediate step towards executing the SQL query. This QP tree is then converted into an AST which represents the structure of the SQL statement. An example QP tree can include a root node of sub-query, intermediate nodes of SELECT clause, FROM clause, and WHERE clause with respective lead nodes of SUM (a), table T1, and a=1.

Continuing, the QC tree can be described as transition tree between the QP tree and the QO tree. During query compilation, the QP is converted to a QC tree and then converted to initial QO tree. An example initial QO tree can include a root node of SELECT a, sub [b], intermediate nodes of ORDER BY a, GROUP BY a, and WHERE a+1, and a root node of V1. The QC tree represents an intermediate state in query processing. Both the QC tree and the QO tree are forms of relational algebra trees. However, the nodes of the QO tree contain more detailed information than the nodes of the QC tree. For example, in the case of a table node, both the nodes of the QC tree and the nodes of the QO tree include the database name, schema name, and table name. The QO node, though, also specifies the table type, such as whether it is a row table or column table. The QC tree serves as a foundation for constructing the more detailed QO tree.

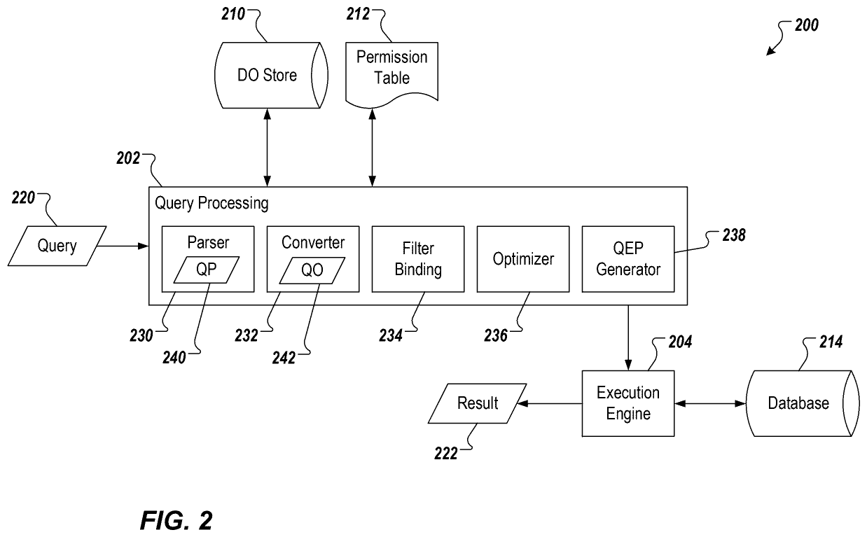

FIG. 2 depicts a conceptual architecture 200 for instituting row-level security in database systems in accordance with implementations of the present disclosure. In the example of FIG. 2, the conceptual architecture 200 includes a query processing system 202, an execution engine 204, a database object store 210, a permission table 212, and a database 214. In some examples, the query processing system 202 includes a parser module 230, a converter module 232, a filter binding module 234, an optimizer module 236, and a QEP generator 238.

As described in further detail herein, a query 220 is received and is processed by the query processing system 202 to generate a query execution plan (QEP) that is executed by the execution engine 204 to query one or more tables stored within the database 214 to generate a result 222. In some examples, the result 222 includes one or more views on data stored in the database 214. As described in further detail herein, row-level security is applied to at least one of the calculation views of the result 222 in accordance with implementations of the present disclosure, such that data represented in the at least one calculation view is limited (e.g., only includes data that a user that issued the query 220 is authorized to access).

In further detail, during a design-time (e.g., prior to receiving queries for application of row-level security), database objects that are to be protected by row-level security are generated and stored in the database object store 210. For each database object, a row-level security protection flag is saved in metadata of the database object. For example, the metadata can include a row-level security protection flag that can be assigned a first value (e.g., 0) indicating that the respective database object (e.g., calculation view) does not have row-level security, or a second value (e.g., 1) indicating that the respective database object (e.g., calculation view) does have row-level security. In some examples, the metadata also specify the condition provider procedure that is to be used to generate the filter string (e.g., the metadata includes “TEST_SCHEMA”. “P1”).

The following non-limiting example data schema and calculation scenario (database object) can be considered:

```
drop schema “TEST_SCHEMA” cascade;
create schema “TEST_SCHEMA”;
set schema “TEST_SCHEMA”;
CREATE COLUMN TABLE T1
      (
          name VARCHAR(64) NOT NULL UNIQUE,
          manager VARCHAR(64) NULL,
          ssn VARCHAR(19) PRIMARY KEY,
          num INTEGER,
          tel NVARCHAR(32) -- e.g. 030-0000-0000 or 01801 0000 0000
      );
insert into T1 values(‘John’, NULL, ‘1111-2222-3333-4444’, 1, ‘030 1234 1234’);
insert into T1 values(‘Jaine’, ‘John’, ‘1111-2222-3333-5555’, 2, ‘069-1234-1234’);
insert into T1 values(‘Jack’, ‘John’, ‘1111-2222-3333-6666’, 3, ‘06227 1234 1234’);
insert into T1 values(‘Jerome’, ‘Jack’, ‘1111-2222-3333-7777’, 4, ‘0351-1234-1234’);
DROP CALCULATION SCENARIO “TEST_OBJECT_CALCSCEN” CASCADE;
CREATE CALCULATION SCENARIO “TEST_OBJECT_CALCSCEN” using ‘<?xml
version=“1.0” encoding=“utf-8” ?>
<cubeSchema version=“2” operation=“createCalculationScenario”
defaultLanguage=“en”>
  <calculationScenario name=“TEST_OBJECT_CALCSCEN”> <scenarioHints
enforceSqlExecution=“false” invokerMode=“false”/>
      <dataSources>
    <tableDataSource name=“testSource” source=“TEST_SCHEMA:T1” >
      <attributes>
        <allAttribute />
      </attributes>
    </tableDataSource>
      </dataSources>
      <calculationViews>
        <projection name=“testSourceProj” defaultViewFlag=“true”>
          <inputs>
            <input name=“testSource” />
          </inputs>
          <attributes>
            <allAttribute />
          </attributes>
        </projection>
      </calculationViews>
  </calculationScenario>
</cubeSchema>’;
```

### Listing 1: Example Data Schema with Calculation Scenario

The following non-limiting example calculation view (database object) can be considered:

```
--create a calculation view protected by row level security
CREATE COLUMN VIEW “CV1” TYPE CALCULATION WITH PARAMETERS (
  ‘PARENTCALCINDEX’=‘TEST_OBJECT_CALCSCEN’,
  ‘PARENTCALCNODE’=‘testSourceProj’
) STRUCTURED FILTER CHECK;
```

### Listing 2: Example View

In the example of Listing 2, a calculation view, with view name CV1, on the data schema of Listing 1 is to have row-level security applied.

In some implementations, during the design-time, the permission table 212 is defined. In some examples, the permission table 212 records filters, schema names, and view names. For example:

--create permission table
CREATE COLUMN TABLE “TEST_SCHEMA”.“MAPPING_TABLE” (“filter_string”
varchar(5000), “userName” varchar(256));
INSERT INTO “MAPPING_TABLE” VALUES(‘NUM < 3’, ‘SYSTEM’);

### Listing 3: Example Portion of Permission Table

Using the example of Listing 3, the permission table 212 corresponds to the data schema of Listing 1 and indicates that a filter string (‘NUM<3’) is to be applied to the data schema (‘TEST_SCHEMA’).

In some implementations, during design-time, row-level security is defined on protected database objects (e.g., calculation views) in order to manage binding between the database objects and a condition provider procedure. An example condition provider procedure can be provided as:

```
--create condition provider procedure
CREATE PROCEDURE “TEST_SCHEMA”.“P1” (OUT VAL VARCHAR(5000))
  LANGUAGE SQLSCRIPT SQL SECURITY DEFINER READS SQL DATA AS
  BEGIN
    DECLARE v_Val VARCHAR(5000);
    DECLARE CURSOR c_GetOneOperand FOR
      SELECT “filter_string” FROM “TEST_SCHEMA”.“MAPPING_TABLE”
WHERE “userName” = SESSION_USER;
    OPEN c_GetOneOperand;
    FETCH c_GetOneOperand INTO v_Val;
    IF c_GetOneOperand::NOTFOUND THEN
      VAL = NULL;
    ELSE
      VAL = v_Val;
    END IF;
    CLOSE c_GetOneOperand;
  END;
```

### Listing 4: Example Condition Provider Procedure

An example row-level security to bind a protected database object and condition provider procedure can be provided as:
--create row level security to bind protected database object and condition provider procedure

```
CREATE STRUCTURED FILTER “TEST_SCHEMA”.“SF1” FOR
  SELECT ON TEST_SCHEMA.CV1
    CONDITION PROVIDER “TEST_SCHEMA”.“P1”;
```

### Listing 5: Example Filter Binding

In the examples of Listings 4 and 5, the example condition provider procedure identified in the metadata for a calculation view node is “TEST_SCHEMA”. “P1”.

In some implementations, during runtime, queries are received and are processed to generate query results. For example, the query 220 is received by the query processing system 202 and is processed to provide the result 222. For purposes of non-limiting illustration, example query statements that can be included in queries, such as the query 220, can be considered and provided as:

SELECT * FROM “TEST_SCHEMA”.“CV1”

### Listing 6: Example Query Statement

SELECT * FROM “TEST_SCHEMA”.“CV1” WITH HINT
(NO_CALC_VIEW_UNFOLDING)

### Listing 7: Example Query Statement

In the above, Listing 6 represents a calculation view that can be unfolded and Listing 7 represents a calculation view that cannot be unfolded.

In response to receiving the query 220, the query 220 is parsed to provide a QP tree 240, which is preprocessed (e.g., by a preprocessor) to transform the QP tree 240 for some types of query statements, such as query statements with sub-queries and views, to improve efficiency of the QP tree 240. In some examples, a semantics check is performed (e.g., by a semantics checker) to ensure that the QP tree 240 is semantically correct. The semantics check can generally be described as determining whether query statements are meaningful in terms of what is being requested from the database system. That is, for example, whether the data objects (e.g., tables, columns, views, procedures) in the statement actually exist within the database system. If the semantics check passes, the converter 232 converts the QP tree 240 to a QC tree and converts the QC tree to an initial QO tree 242.

In accordance with implementations of the present disclosure, the initial QO tree 242 is traversed (e.g., by the filter binding module 234) to define a set of calculation view nodes (e.g., [n_{CV1}, . . . , n_{CVm}]) that are to have row-level security applied. Here, a calculation view node is a node of the initial QO tree 242 that represents a calculation view (e.g., CV1) on data. In some examples, whether a calculation view is to have row-level security applied is determined by checking the row-level security protection flag of the metadata of the respective calculation view. In some implementations, for each calculation view node (e.g., n_{CVi}), a respective condition provider procedure is retrieved (e.g., see the example of Listing 4). If all calculation views represented by the calculation view nodes [n_{CV1}, . . . , n_{CVm}] can be unfolded (e.g., none include HINT (NO_CALC_VIEW_UNFOLDING) within the query 220), the condition provider procedures are executed to add filter strings from the permission table 212.

In some examples, the filter bindings are used to determine whether a calculation view is bound to a filter and, if so, the condition provider is executed to add a filter from permission table during query processing. In some examples, for each calculation view node, non-relational calculation models are translated to relational form, filter strings are added as post-filters, and the calculation view is stripped and the underlying catalog objects (e.g., tables) are exposed in the final QO tree. The filter strings are converted to QO predicates, which are injected into the respective calculation view node in the initial QO tree 242 to be included as part of a final QO tree. A calculation view is based on calculation scenarios defined on, for example, a column table. A post-filter means that the predicate (filter string) has to be evaluated/applied row-by-row after retrieving/materializing rows from the column table.

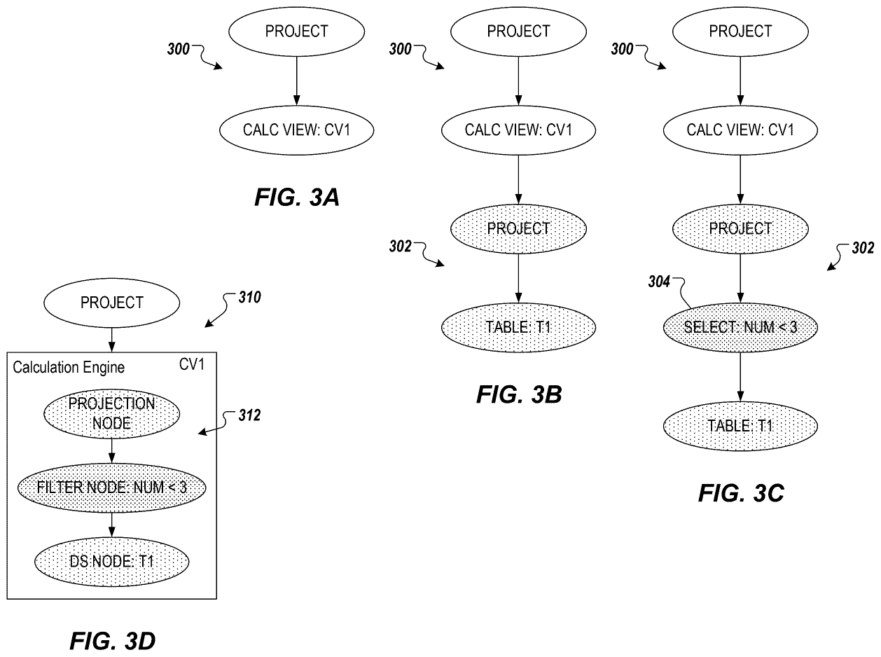

FIGS. 3A-3C depict examples to illustrate implementations of the present disclosure. FIG. 3A depicts a representation of a QO tree 300 of a calculation view (CV1) prior to unfolding. FIG. 3B depicts a representation of the QO tree 300 after the calculation view is unfolded, which results in a QO sub-tree 302, in relational form, being added. FIG. 3C depicts a representation of the QO tree 300 and QO sub-tree 302 with a filter string 304 being injected as a select operator. More particularly, and with reference to the non-limiting examples above, the filter string is defined in the permission table 212 (e.g., ‘NUM<3’ for SYSTEM user in example of Listing 3) and is retrieved (e.g., by the optimizer 235) by executing the condition provider procedure (e.g., “TEST_SCHEMA”. “P1” in the example of Listing 4). In the example of FIG. 3C, the calculation view CV1 will be removed and its child project operator (which is redundant after removal of CV1) will also be removed from the QO tree (i.e., the root PROJECT node, and the CALC VIEW: CV1 child node are deleted).

Referring again to FIG. 2, in some implementations, the QEP generator 238 processes the final QO tree to generate a QEP. The QEP is processed by the execution engine 204, which queries the database 214 to retrieve data and execute calculations responsive to the query 220, the data being filtered based on the filter strings that had been added to the initial QO tree to provide the final QO tree. In some examples, the execution engine can represent a query execution engine (e.g., a SQL execution engine, such as HEX (the SAP Hana Execution engine) and a calculation engine (CE), discussed above. If at least one calculation view cannot be unfolded, then QEPs of the calculation views are processed by the CE. If all of the calculation views can be unfolded, then the QEP is executed by the query execution engine (e.g., HEX).

FIG. 3D depicts a representation of a QEP 310 for the calculation view (CV1) processed by an execution engine (e.g., calculation engine), which includes an internal QEP 312 generated by the execution engine. The example of FIG. 3D represents an instance where the calculation view cannot be unfolded (e.g., the query statement included HINT (NO_CALC_VIEW_UNFOLDING) for CV1). As such, the calculation view is treated as black-box by the optimizer and instead, the execution engine will instantiate/optimize the calculation view to generate and execute the internal QEP 312. Here, if calculation view could be unfolded by optimizer, then optimizer knows its internal structure (e.g., underlying objects) after unfolding. In the example, because the calculation view cannot be unfolded by optimizer, the optimizer does not optimize the calculation view and also does not know its internal structure at all. Hence, it is referred to as being black-box to optimizer. In such case calculation view will be processed by calculation engine (not the HEX engine).

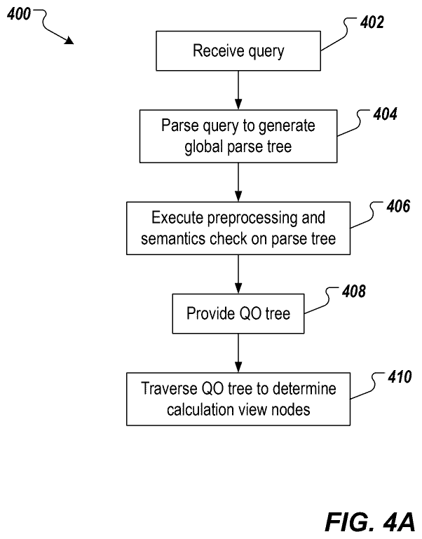

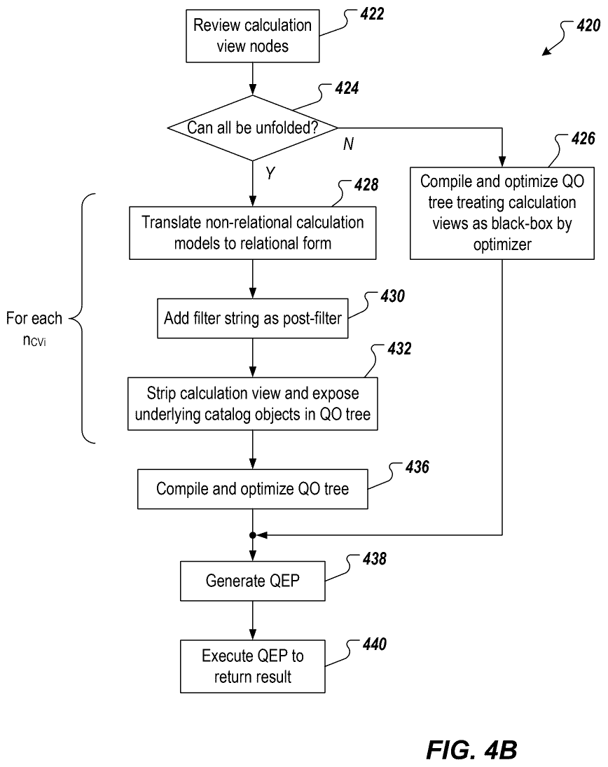

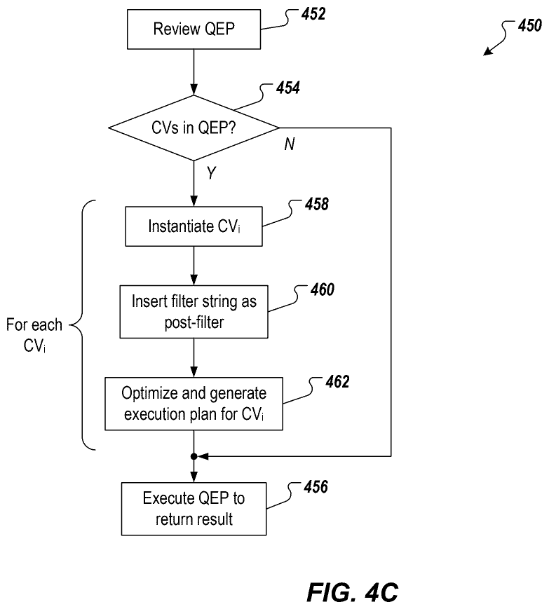

FIG. 4A depicts an example process 400 that can be executed in accordance with implementations of the present disclosure. In some examples, the example process 400 is provided using one or more computer-executable programs executed by one or more computing devices.

A query is received (402). For example, and as described in detail herein with reference to FIG. 2, the query 220 can be received by the query processing system 202 from a user (e.g., the user 112 of FIG. 1). The query is parsed to generate a QP tree (404), and preprocessing and a semantics check are executed on the QP tree (406). For example, and as described in detail herein, the query 220 is parsed to provide the QP tree 240, which is preprocessed (e.g., by a preprocessor) to transform the QP tree 240 for some types of query statements, such as query statements with sub-queries and views, to improve efficiency of the QP tree 240. In some examples, a semantics check is performed (e.g., by a semantics checker) to ensure that the QP tree 240 is semantically correct. An initial QO tree is provided (408). For example, and as described in detail herein, if the semantics check passes, the QP tree 240 is converted to a QC tree, and the QC tree is converted to an initial QO tree 242 (e.g., by the converter 232). The QO tree is traversed to determine a set of calculation view nodes (410). For example, and as described in detail herein, the filter binding module traverses the initial QO tree to identify calculation view nodes in the initial QO tree and add the calculation view nodes to a set of calculation view nodes [n_{CV1}, . . . , n_{CVm}].

FIG. 4B depicts an example process 420 that can be executed in accordance with implementations of the present disclosure. In some examples, the example process 420 is provided using one or more computer-executable programs executed by one or more computing devices.

The set of calculation view nodes [n_{CV1}, . . . , n_{CVm}] is reviewed (452) and it is determined whether all calculation views can be unfolded (424). For example, and as described herein, it is determined whether any of the calculation views is blocked from unfolding (e.g., none include HINT (NO_CALC_VIEW_UNFOLDING) within the query 220). If at least one of the calculation views cannot be unfolded, the QO tree is compiled and optimized with all calculation views being treated as black-box by the optimizer (426). For example, and as described herein, the calculation views are included in the QEP that is ultimately generated but are not optimized by the optimizer.

If all of the calculation views can be unfolded, each calculation view node n_{CVi} is processed to translate non-relational calculation models to relational form (428) and strip the calculation view and expose the underlying catalog objects in the QO tree (432). In some examples, one or more of the calculation view node n_{CVi} is processed to add a filter string as a post-filter (430). For example, if a calculation view node n_{CVi} is bound to a filter (e.g., per the example filter binding of Listing 5), then a filter string as a post-filter. The final QO tree (i.e., the initial QO tree with post-filters added) is compiled and optimized (436).

A QEP is generated (438). For example, and as described herein, the QEP generator 238 of FIG. 2 processes the (compiled and optimized) final QO tree to generate the QEP. The QEP is executed to return a result (440).

FIG. 4C depicts an example process 450 that can be executed in accordance with implementations of the present disclosure. In some examples, the example process 450 is provided using one or more computer-executable programs executed by one or more computing devices. In some examples, the example process 450 represents execution of the QEP (e.g., 440 of FIG. 4B).

A QEP is reviewed (452) and it is determined whether there are any calculation views in the QEP (454). For example, and as described herein, if all of the CVs can be unfolded, all of the CVs are unfolded, such that none are present in the QEP. However, and as also described herein, if at least one of the CVs cannot be unfolded, none of the CVs are unfolded, such that CVs are present in the QEP. If there are no CVs in the QEP, the QEP is executed to return the result (456). For example, the QEP can be entirely executed by the query execution engine (e.g., HEX) to return the result.

If there are CVs in the QEP, each CVᵢ is instantiated (458) and is optimized to generate a QEPᵢ for the respective CVᵢ (462). In some examples, one or more of the calculation views CVᵢ is processed to add a filter string as a post-filter (460). For example, if a calculation view CVᵢ is bound to a filter (e.g., per the example filter binding of Listing 5), then a filter string as a post-filter. This is depicted in the example of FIG. 3D. The QEP is executed to return a result (456). For example, multiple QEPs can be provided and can include a QEP executed by a query execution engine (e.g., HEX) and one or more calculation view QEPs executed by a calculation engine, the results of the QEPs being combined to return the (overall) result.

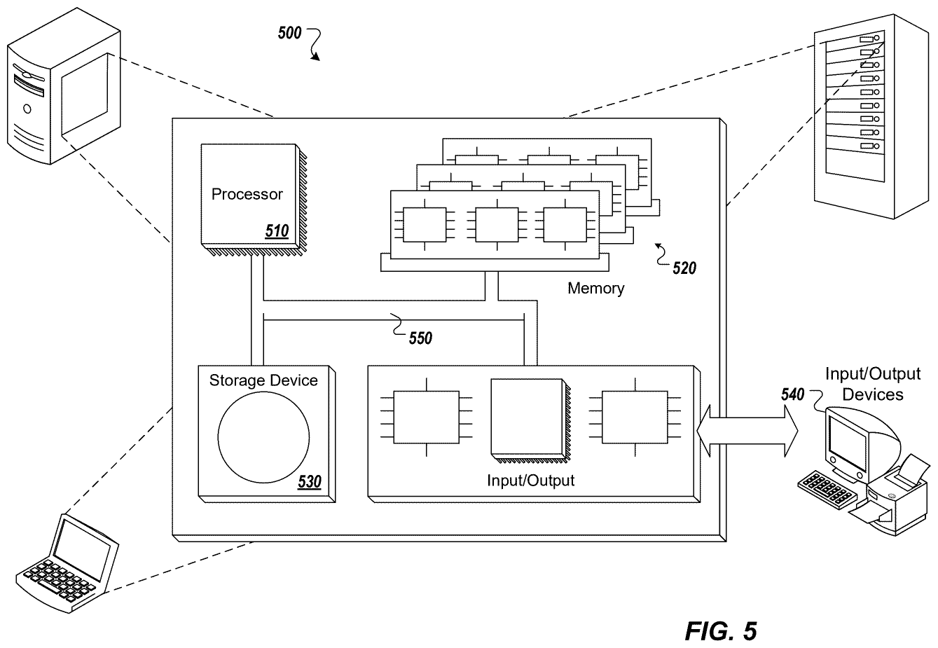

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for row-level security in database systems, the method being executed by one or more processors and comprising:
providing a first initial query tree responsive to a first query for querying a database system, the first initial query tree comprising a first set of calculation view nodes;
determining that all calculation views represented on the first set of calculation view nodes can be unfolded, and in response;
for a first calculation view node in the first set of calculation view nodes:
identifying a first condition provider procedure that is to be executed,
executing the first condition provider procedure to provide a first filter string, and
inserting the first filter string into the initial query tree;
providing a first final query tree comprising the first initial query tree and inserted filter strings;
generating a first query execution plan;
executing, by an execution engine, the first query execution plan to query a database and generate first results responsive to the first query; and
returning the first results.

2. The method of claim 1, wherein the first filter string is determined by the first condition provider procedure from a permission table.

3. The method of claim 2, wherein the permission table defines a set of filter strings that are to be applied to respective calculation views of calculation view nodes.

4. The method of claim 1, wherein providing a first final query tree comprising the first initial query tree and inserted filter strings comprises, for the first calculation view, translating a non-relational calculation model to relational form and adding the first filter string as a post-filter into the initial query tree.

5. The method of claim 4, wherein the post-filter comprises a SELECT operation.

6. The method of claim 1, further comprising, for a second calculation view node in the set of calculation view nodes, determining that no condition provider procedure that is to be executed, such that the second calculation view node is absent filtering.

7. The method of claim 1, further comprising:
providing a second initial query tree responsive to a second query for querying the database system, the second initial query tree comprising a second set of calculation view nodes;
determining that at least one calculation view represented on the second set of calculation view nodes cannot be unfolded, and in response;
generating a second query execution plan comprising the at least one calculation view, and
generating a third query execution plan specific to the at least one execution view and comprising a filter;
executing, by a query execution engine of the execution engine, the second query execution plan to query the database and generate second results responsive to the second query;
executing, by a calculation engine of the execution engine, the third query execution plan to query the database and generate third results responsive to the second query; and
returning the second results and the third results.

8. A non-transitory computer-readable storage medium coupled to one or more processors and having instructions stored thereon which, when executed by the one or more processors, cause the one or more processors to perform operations for row-level security in database systems, the operations comprising:
providing a first initial query tree responsive to a first query for querying a database system, the first initial query tree comprising a first set of calculation view nodes;
determining that all calculation views represented on the first set of calculation view nodes can be unfolded, and in response;
for a first calculation view node in the first set of calculation view nodes:
identifying a first condition provider procedure that is to be executed,
executing the first condition provider procedure to provide a first filter string, and
inserting the first filter string into the initial query tree;
providing a first final query tree comprising the first initial query tree and inserted filter strings;
generating a first query execution plan;
executing, by an execution engine, the first query execution plan to query a database and generate first results responsive to the first query; and
returning the first results.

9. The non-transitory computer-readable storage medium of claim 8, wherein the first filter string is determined by the first condition provider procedure from a permission table.

10. The non-transitory computer-readable storage medium of claim 9, wherein the permission table defines a set of filter strings that are to be applied to respective calculation views of calculation view nodes.

11. The non-transitory computer-readable storage medium of claim 8, wherein providing a first final query tree comprising the first initial query tree and inserted filter strings comprises, for the first calculation view, translating a non-relational calculation model to relational form and adding the first filter string as a post-filter into the initial query tree.

12. The non-transitory computer-readable storage medium of claim 11, wherein the post-filter comprises a SELECT operation.

13. The non-transitory computer-readable storage medium of claim 8, wherein operations further comprise, for a second calculation view node in the set of calculation view nodes, determining that no condition provider procedure that is to be executed, such that the second calculation view node is absent filtering.

14. The non-transitory computer-readable storage medium of claim 8, wherein operations further comprise:
providing a second initial query tree responsive to a second query for querying the database system, the second initial query tree comprising a second set of calculation view nodes;
determining that at least one calculation view represented on the second set of calculation view nodes cannot be unfolded, and in response;
generating a second query execution plan comprising the at least one calculation view, and
generating a third query execution plan specific to the at least one execution view and comprising a filter;
executing, by a query execution engine of the execution engine, the second query execution plan to query the database and generate second results responsive to the second query;
executing, by a calculation engine of the execution engine, the third query execution plan to query the database and generate third results responsive to the second query; and
returning the second results and the third results.

15. A system, comprising:
a computing device; and
a computer-readable storage device coupled to the computing device and having instructions stored thereon which, when executed by the computing device, cause the computing device to perform operations for row-level security in database systems, the operations comprising:
providing a first initial query tree responsive to a first query for querying a database system, the first initial query tree comprising a first set of calculation view nodes;
determining that all calculation views represented on the first set of calculation view nodes can be unfolded, and in response;
for a first calculation view node in the first set of calculation view nodes:
identifying a first condition provider procedure that is to be executed,
executing the first condition provider procedure to provide a first filter string, and
inserting the first filter string into the initial query tree;
providing a first final query tree comprising the first initial query tree and inserted filter strings;
generating a first query execution plan;
executing, by an execution engine, the first query execution plan to query a database and generate first results responsive to the first query; and
returning the first results.

16. The system of claim 15, wherein the first filter string is determined by the first condition provider procedure from a permission table.

17. The system of claim 16, wherein the permission table defines a set of filter strings that are to be applied to respective calculation views of calculation view nodes.

18. The system of claim 15, wherein providing a first final query tree comprising the first initial query tree and inserted filter strings comprises, for the first calculation view, translating a non-relational calculation model to relational form and adding the first filter string as a post-filter into the initial query tree.

19. The system of claim 18, wherein the post-filter comprises a SELECT operation.

20. The system of claim 15, wherein operations further comprise, for a second calculation view node in the set of calculation view nodes, determining that no condition provider procedure that is to be executed, such that the second calculation view node is absent filtering.
